(19) United States
(12) Patent Application Publication
(10) Pub. No.: US 2022/0030887 A1
(43) Pub. Date: Feb. 3, 2022

(54) COCONUT FLOUR COMPOSITION AND METHOD FOR MAKING PASTAS AND PIZZAS

(71) Applicant: Luca PORRINO PERASSI, Atlatlahucan (MX)

(72) Inventor: Luca PORRINO PERASSI, Atlatlahucan (MX)

(21) Appl. No.: 17/035,511

(22) Filed: Sep. 28, 2020

(30) Foreign Application Priority Data
Aug. 3, 2020 (MX) 2020/008165

(51) Int. Cl. A21D 13/066; A21D 13/04; A21D 13/41; A23L 19/00

(52) U.S. Cl. CPC A21D 13/066; A21D 13/04; A23V 2002/00; A23L 19/01; A21D 13/41

(57) ABSTRACT

A method of making a flour for pizzas and pastas has the steps of extracting coconut water from a coconut, drying the meat of the coconut at a temperature between 4° C. in 10° C. until the meat is dry, and crushing and grinding the dry meat so as to produce a gluten-free flour. In order to make a pizza, the coconut base flour is mixed with an approximately equal proportion of water, kneaded and heated. The flour for the pizza will include approximately 51.5% of the gluten-free coconut flour.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The present invention relates to pizzas and pastas. More particularly, the present invention relates to the flour used in such pastas and pizzas. Furthermore, the present invention relates to coconut flour as used for the making of pizzas and pastas.

### 2. Description of Related Art Including Information Disclosed Under 37 CFR 1.97 and 37 CFR 1.98

Pizza is undoubtedly one of the most popular fast foods today. Pizza can be found in almost every city of the world, as well as in various settings, such as movies. Pizza has become one of the prominent foods consumed by humanity Pizza can be found in high-profile restaurants, grocery stores, fast food restaurants, businesses and in most homes in the world.

The majority of people are raised on a very high carbohydrate diet. As such, people become addicted to white flour-based, sweet, high-carbohydrate high fat content snack foods, such as cookies, pastries, donuts, cakes, pies, and chips. People also enjoy high carbohydrate-containing staples such as pizza, pasta, bread, rolls, bagels, muffins and the like. Such high-carbohydrate, high-calorie, high-fat, low-nutritional foods are readily available in grocery stores and fast food restaurants. As such, it is desirable for the baking industry to provide a baking flour that can be used to bake all of these highly desirable and popular commonly-baked foods while eliminating the presence of unhealthy carbohydrates and having reduced fat and calorie content, while maintaining an appetizing taste and desirable texture. For those consumers who are at risk pertaining to the consumption of gluten, it is also desirable to provide a gluten-free flour.

Celiac disease is an autoimmune condition caused by gluten, a protein found in wheat, rye, barley and oats. Celiac disease results in damage to the small intestine. Celiac disease can lead to poor nutritional absorption and often causes digestive symptoms such as bloating, abdominal pain and diarrhea. It can also cause anemia, low-iron levels and excessive tiredness. Treatment of celiac disease involves a strict and lifelong gluten-free diet. Gluten intolerance or gluten insensitivity is a condition with symptoms similar to celiac disease, without the damage to the small intestine. Individuals suffering from gluten intolerance or insensitivity report an improvement in their condition when gluten is eliminated from their diet.

Gluten acts as a binder and provides structure and elasticity, as well as aiding moisture retention. A common drawback for many gluten-free flours is that when substituted for wheat flour in many baking and cooking applications, the resulting product may characteristically be more dense and/or fragile than its wheat flour equivalent. Additional agents, such as xanthan and/or guar gums, or ground seeds, such as phyllium, flax or chia, are typically used in an attempt to mimic the functions of gluten. Furthermore, the use of strongly-flavored flours, such as buckwheat, or the addition of ground seeds, can also affect the taste of the food. As such, there is a need for a gluten-free flour that can be used in baking and other cooking applications in order to provide a more palatable texture and/or flavor and more closely mimic the taste and texture achieved by wheat flour. There is also a need to provide a gluten-free flour that gives the consumer a more palatable and familiar experience.

In the past, various patents and patent application publications have issued with respect to gluten-free flours. For example, U.S. Pat. No. 8,753,701, issued on Jun. 17, 2014 to Jeong et al., discloses a premixed composition of glutinous rice cake for baking and microwave ovens. This is a premixed composition of glutinous rice cake that maintains the shape and a softness for twenty-four hours without adding an inhibitor. In particular, the mixture includes glutinous rice powder having 200 to 400 μm of average grain size and comprising less than five weight percent of glutinous rice powder of below 200 mesh.

U.S. Pat. No. 10,555,537, issued on Feb. 11, 2020 to Charak et al., describes a composition for low-gluten and low-carbohydrate baked and pastry goods. This composition includes a flour obtained for one or more nuts and/or oilseeds of non-legumes, mucilage, polysaccharide-containing plant products or mucilage polysaccharides isolated from these plant products, and protein components consisting of at least 40% animal protein.

U.S. Patent Application Publication No. 2014/0161963, published on Jun. 12, 2014 to T. J. Bernacchi, describes a zero-net carbohydrate baking flour that is high in protein and fiber content and low in fat and calorie content. The proteins and fibers are blended together in the presence of a bonding agent. This zero-net carbohydrate flour is prepared so as to be gluten-free.

U.S. Patent Application Publication No. 2019/0200623, published on Jul. 4, 2019 to S. Carlesso, describes a gluten-free flour composition for use in baking and in other culinary applications. This flour composition comprises popcorn flour that is used as a substitute for wheat and other gluten-containing flours.

U.S. Patent Application Publication No. 2019/0254291, published on Aug. 22, 2019 to Brooks et al., teaches a microalgal flour. This flour is manufactured from edible and inedible heterotrophic fermentation feedstocks, including cornstarch, sugarcane, glycerol, and depolymerized cellulose.

U.S. Patent Application Publication No. 2020/0128834, published on Apr. 30, 2020 to W. J. Westley, discloses a food product composition that provides for gluten-free or gluten-reduced food products having organoleptic properties. This composition includes rice flour, sweet rice flour, oat flour, millet flour, buckwheat flour, teff flour, potato flour, xanthan gum and maltodextrin.

International Publication No. WO2019/153070, published on Aug. 15, 2019 to A. Oladiwura, teaches a dough composition and process for manufacture. This dough composition is for a ketogenic diet, a low-carbohydrate diet, a sugar-restricted diet, and/or a gluten-reduced diet. The dough composition comprises psyllium powder, pea protein, pea fiber, and chickpea flour.

It is an object of the present invention to provide a gluten-free flour for use in the manufacture of pizzas and pasta.

It is another object of the present invention provide a flour that can be easily kneaded or flattened.

It is another object of the present invention to provide a flour that does not break when baked.

It is another object of the present invention provide a flour that can be formed into a very thin and light shape.

It is another object the present invention provide a gluten-free flour that has a consistency similar to wheat flour but with a white color.

It is another object of the present invention provide a coconut flour in which the flavor of coconut is minimal.

It is another object of the present invention to provide a gluten-free flour that enhances the flavor of the product baked or cooked from such flour.

It is still another object of the present invention to provide a gluten-free flour that does not stick to the baking tray.

It is still a further object of the present invention provide a gluten-free flour which enhances the health and well-being of the persons consuming products that are baked from such gluten-free flour.

It is another object of the present invention provide a gluten-free flour that decreases blood pressure, reduces cholesterol and triglycerides, reduces the risk of thrombosis or strokes, and can achieve weight loss in persons consuming such gluten-free flour.

It is still another object of the present invention provide a gluten-free flour that has antioxidant properties, and is rich in fibers and minerals.

These and other objects and advantages of the present invention will become apparent from a reading of the attached specification and appended claims.

### BRIEF SUMMARY OF THE INVENTION

The present invention is a method of making a flour for pizzas and pasta. This method comprises the steps of: (1) extracting coconut water from a coconut; (2) drying the meat of the coconut at a temperature of between 4° C. in 10° C. until the meat is dry; and (3) crushing and grinding in the dry meat so as to produce a gluten-free flour.

The present invention is also a flour composition for pizzas and pasta. This flour composition comprises gluten-free coconut flour of 51.5% by weight and complementary ingredients of 48.5% by weight. The complementary ingredients include corn starch of 12.5% by weight, gluten-free flour of 10% by weight, rice flour of 7% by weight, starch of 5% by weight, oil of 3% by weight, sugar of 2.5% by weight, dextrose of 2% by weight, vegetable shortening of 2% by weight, egg albumin of 1% by weight, xanthan gum of 0.8% by weight, and yeast of 0.7% by weight.

The present invention is also a method for making a pizza. This method comprises: (1) mixing a gluten-free coconut base flour with an approximately even a proportion of water; (2) kneading the mixture until a desired consistency, size and shape is obtained; (3) placing the kneaded mixture onto a baking tray; (4) placing the baking tray into a heated oven; (5) heating the placed kneaded mixture in the heated oven for a period of time; and (6) removing the heated dough for from the heated oven after a period of time. In the preferred embodiment of the present invention, the period of time is twelve minutes. Also, in the preferred embodiment the present invention, the gluten-free coconut base flour is of one kilogram. The water is one liter. It is recognized that the period of time can be additional time or less time. The amount of the components can also be more or less.

This foregoing Section is intended to describe, with particularity, the preferred embodiments of the present invention. It is understood that modifications to these preferred embodiments can be made within the scope of the present claims. As such, this Section should not to be construed, in any way, as limiting of the broad scope of the present invention. The present invention should only be limited by the following claims and their legal equivalents.

### DETAILED DESCRIPTION OF THE INVENTION

The present invention is a method of making a flour for use in pizzas and pasta. In particular, coconut water is extracted from a coconut. The meat of the coconut is then slowly dried at a temperature between 4° C. in 10° C. until the meat is dry. Ultimately, this dry meat is then crushed and ground so as to produce a gluten-free flour.

This gluten-free coconut base flour for use of making pizzas and pastas represents a great alternative for persons that are looking for healthier foods. It is known that gluten is a protein found in wheat and is used in food products because of its visco-elastic properties, elasticity and fluffiness. However, the quality of protein from wheat is very low since it lacks essential amino acids. Since gluten is a protein, it must be digested and broken down into smaller fractions (called “peptides”). It is known that there are people that have difficulty digesting gluten. The gluten can end up in the small intestine and cause damage and sensitivity. It is estimated that 1% of people in the world suffer from celiac disease and which is characterized by gluten intolerance. Health specialists recommend the consumption of a minimal amount of gluten in daily diets. A reduction in gluten consumption can produce a decrease in blood pressure, a reduction of cholesterol and triglycerides, a reduction in the risk of thrombosis or strokes, and weight lost.

The gluten-free coconut base flour that has antioxidant properties. This gluten-free coconut base flour is rich in fibers and minerals such as potassium, phosphorus, calcium, iron, and vitamins C, D and E.

The gluten-free flour produced by the method of the present invention is unique from other coconut-based gluten-free flour. This is because this formula only requires the addition of water. In order to prepared the dough, it only necessary to add an equal amount of water and then mix the flour and water in a mixer. This dough is ready for use by people that wish to prepare pastas and pizzas.

Another important feature the present invention is that once it is mixed and the dough is created, the dough can be flattened with a rolling pin, with hands, or with any other kitchen utensil that allows kneading. No other coconut flour allows kneading without having to add other ingredients or elements such as salt, yeast, oil or other products. The consistency of the dough is such that it does not break. The dough can be made very thin and light. The consistency of the dough is very similar to wheat flour, but has a white color since the base of the flour is white coconut meat. There is no other coconut flour that is used which is similar to the consistency of wheat flour and is gluten-free.

It is also important to note that the flavor of the coconut in the present invention is minimal. The formula created has a very light taste of coconut. This allows the final flavor of the pizza or pasta to be pleasant. Users will only perceive a slight taste of coconut. The coconut is not the dominant flavor of the pizza or pasta. When this dough is baked, it will not stick to the baking tray. As such, it is not necessary to add flour or oil to the tray.

In particular, the composition of the flour of the present invention is gluten-free coconut flour of 51.5% by weight and complementary ingredients of 48.5% by weight. In particular, the complementary ingredients include corn starch of 12.5% by weight, gluten-free flour of 10% by weight, rice flour of 7% by weight, starch of 5% by weight, oil of 3% by weight, sugar of 2.5% by weight, dextrose of 2% by weight, vegetable shortening of 2% by weight, egg albumin of 1% by weight, xanthan gum of 0.8% by weight, and yeast of 0.7% by weight.

The present invention is also a method for making a pizza using the gluten-free flour of the present invention. In particular, this method includes the step of mixing the gluten-free coconut base flour with an approximately even amount of water. The mixture is kneaded until it has the desired consistency, size and shape. The kneaded dough is then placed into a baking tray. This baking tray, along with the kneaded dough, is placed into an oven for a period of time. The heated dough from the heated oven can then be removed after a certain period of time. In the preferred embodiment the present invention, the period of time is twelve minutes. The gluten-free coconut base flour will be approximately one kilogram and the water will be approximately one liter. However, it is important to note that various other proportions and times can be used in order to achieve the desired result.

This process is very useful because it is easy to prepare. It is only necessary to add water to the flour in order to make the dough. As such, the preparation of the pizza can be a very fast process taking between twenty and twenty-five minutes. Since there is almost no complexity in the preparation of the pizza dough, the pizza can be made at home by those with little or no experience. This is carried out while achieving a gluten-free pizza dough.

The foregoing disclosure and description of the invention is illustrative and explanatory thereof Various changes in the details of the illustrated construction can be made within the scope of the appended claims without departing from the true spirit of the invention. The present invention should only be limited by the following claims and their legal equivalents.

I claim:

1. A method of making a flour for pizzas and pasta, the method comprising:
extracting coconut water from a coconut;
drying meat of the coconut at a temperature between 4° C. in 10° C. until the meat is dry; and
crushing and grinding the dry meat so as to produce a gluten-free flour.

2. A flour for pizzas and pastas, the flour comprising:
gluten-free coconut flour of 51.50% by weight; and
complementary ingredients of 48.5% by weight.

3. The flour of claim 2, said complementary ingredients comprising corn starch of 12.5% by weight, gluten-free flour of 10% by weight, rice flour of 7% by weight, starch of 5% by weight, oil of 3% by weight, sugar of 2.5% by weight, dextrose of 2% by weight, vegetable shortening of 2% by weight, egg albumin of 1% by weight, xanthan gum of 0.8% by weight, and yeast of 0.7% by weight.

4. A method of making a pizza, the method comprising:
mixing a gluten-free coconut base flour with an approximately equal amount of water;
kneading the mixture until a desired consistency, size and shape is obtained;
placing the kneaded mixture onto a baking tray;
placing the baking tray into a heated oven;
heating the place kneaded mixture in the heated oven for a period of time; and
removing the heated mixture from the heated oven after a period of time.

5. The method of claim 4, further comprising:
extracting coconut water from a coconut;
drying a meat of the coconut at a temperature of between 4° C. in 10° C. until the meat is dry; and
crushing and grinding the dry meat so as to produce the gluten-free coconut base flour.

6. The method of claim 5, the gluten-free coconut base flour comprising:
gluten-free coconut flour of 51.5% by weight; and
complementary ingredients of 48.5% by weight.

7. The method of claim 6, said complementary ingredients comprising corn starch of 12.5% by weight, gluten-free flour of 10% by weight, rice flour of 7% by weight, starch of 5% by weight, oil of 3% by weight, sugar of 2.5% by weight, dextrose of2% by weight, vegetable shortening of2% by weight, egg albumin of 1% by weight, xanthan gum of 0.8% by weight, and yeast of 0.7% by weight.

8. The method of claim 5, the period of time being twelve minutes.

9. The method of claim 5, the gluten-free coconut base flour being one kilogram, the water being one liter.
